(19) United States
(12) Patent Application Publication
(10) Pub. No.: US 2024/0167599 A1
(43) Pub. Date: May 23, 2024

(54) TWO PART CLAMP AND CLAMPING MACHINE FOR AUTOMATICALLY CLAMPING CABLE AND WIRE LOOMS AND HARNESSES, PIPING AND HOSES, AND COILED ELECTRIC CORDS

(71) Applicant: IRAI, LLC, Las Vegas, NV (US)

(72) Inventor: Michael DeAngelo, Las Vegas, NV (US)

(73) Assignee: IRAI, LLC, Las Vegas, NV (US)

(21) Appl. No.: 18/513,458

(22) Filed: Nov. 17, 2023

Related U.S. Application Data
(60) Provisional application No. 63/384,376, filed on Nov. 18, 2022.

(51) Int. Cl. F16L 37/086; F16L 3/10; F16L 47/12

(52) U.S. Cl. CPC F16L 37/086; F16L 3/105; F16L 47/12; F16L 3/1091; F16L 37/244

(57) ABSTRACT

The present invention relates to an apparatus and a system and method for clamping axially extending articles with a new type of two-part clamp comprising an interlocking upper and lower clamp with a feeding mechanism for successively and repeatedly clamping cable and wire looms and harnesses, pipe, nipples, and hoses, and coiled electric cords in an assembly line. A clamp and clamping device are proposed which can, with precise control and flexibility and variable positioning, successively and repeatedly clamp wire looms and cable harnesses, pipe, nipples, and hoses, and coiled electric cords using as required a pressure reading plate in the inner circumference of the clamp on a controlled computer feedback loop to control piston thrust for interlocking a male half clamp within a female-half clamp. A manual tool employing the same clamp halves is also described. The invention is for use in the automotive, boating, electronic, aerospace, and space industries.

### CROSS REFERENCE TO RELATED APPLICATIONS

This application relates to and claims priority under 35 U.S.C. § 119(e) to provisional applications No. 63/384,376 filed Nov. 18, 2022, which is incorporated by reference herein in its entirety.

### BACKGROUND OF THE INVENTION

### 1. Field of the Invention

The present invention relates generally to wire and pipe clamps and clamping devices for wire harnesses and wire looms and coiled electric cords, more specifically, to wire and pipe clamps and coiled electric cords suitable for automated or robotic assembly, and to computer-controlled compression and clamping mechanisms, in the automotive, boating, electronic, aerospace, and space industries.

### Description of the Related Art

There exists currently in the art a limited means to employ clamps and clamping means in automated or robotic assembly without using human hands to position, set, or tighten clamps.

In order to affix a hose to a pipe or extruding element, barb, or nipple or to wrap and enclose multiple wires to hold together, various clamps are provided. These generally comprise, pegs and hole, ratcheted clips, screw-tightening mechanisms, bolt-and-barrel clamps, T-bolt clamps, and push-lock fittings. Most pre-date automated manufacturing assembly and almost all pre-date the use of computers in manufacturing.

Commonly, these clamps are metal with a screw or bolt tightening assembly. The metal is subject to failure due to stress and corrosion, especially in marine environments. The metal may also expand and contract due to fluctuating temperatures causing non-uniform pressures on the circumference of fittings.

Many metal hose clamps rely on a series of perforations cut into the band to engage the screw threads. These perforations eliminate a portion of the cross section of the band, weakening it and allowing it to stretch when tensioned. Stretching leads to microcracking, providing a toehold for corrosion in crevices, a form of metal decay, and subject the clamp to overstress and corrosion. Metal bands, bolts, and screw tightening mechanisms remain subject to stretching, crevice corrosion, “cheese-grating,” and stripping.

The various tensioning mechanisms employed on clamps often add additional space requirements.

A challenge for hose clamps is the need to maintain tension after the initial clamping. Leaks can result from either compression of hoses or variation in temperature. In the first case, over time the hose compresses, leading to reduced clamp tension, and requiring at least one re-tensioning. In the latter case, hoses used on closed cooling systems can experience dramatic temperature swings, from below freezing to well above boiling when in use. This can strain a clamp's capacity to maintain tension on a pressurized hose without causing critical damage. Typically, a solution is a constant-tension clamp, built around either a Belleville spring under the screwhead; or a W-cross-section, lubricated, O-ring-equipped spring liner inside the clamp, which can be utilized on the inner circumference of the clamp.

Many of these clamps are whole circles requiring insertion of two elements before clamping, or whole circles with an opening requiring lateral insertion motions and a limiting equation of the ratio between the claim, the clamp opening, and the object to be clamped, these being subject to human estimation, selection, judgment, and error.

When clamps are a nearly complete circle with one opening or no opening, flexibility of placement and application in the automated placement of a clamp in an assembly line or robotic process is greatly limited.

Generally, these clamps are utilized using the human hand and eye coordination, allowing for human error. Various complex manual motions of squeezing, pinching, twisting, pushing, and screwing are employed to affix and utilize the clamp to accomplish its purpose. Some may require the application of radial force.

These human actions are time consuming, subject to error, and require judgment and estimation by each individual human performing the task, yielding varied and inconsistent results that may lead to future failure.

These human actions as required are generally complex to integrate into an assembly line and are difficult for robots to accomplish.

Further, where machine assemblies have been created to tighten clamps those machines are often themselves too large and cumbersome to integrate into an assembly line, be maneuvered within compartments.

Further, there are no feeding mechanisms or stackable clamps or stacks of clamps that can enable a clamp to be fed successively and repeatedly into a clamping device.

At present, clamps and clamping processing do not integrate pressor sensors, computer-controlled compression arms, or looped computer feedback processes. Without these elements integrated there is no way to determine the integrity of a seal in a clamping process without human accomplishment.

Without a precise series of incremental, exact calibrations of an exact intended closing circumference is limited.

There are limited means for integrating these clamps and clamping processes with computer-controlled processes for repetitive assembly line clamping or robotic application.

Generally, these clamps are without a pressure feedback mechanism, not allowing for the application of a secondary or tertiary clamp of varying pressure.

Generally, there is no automated feeding mechanism for clamps.

Generally, clamps are one piece, limited the flexibility of placement.

Other clamps are a complete circumference, requiring a wire harness to be threaded through a circular opening.

Coiled electric cords are generally manually wrapped with tape, twist ties, or zip locks.

It would be advantageous to have a non-metal clamp of high-performance plastic.

It would be advantageous for the clamps to be able to sustain high temperatures.

It would be advantageous to have a clamp and clamping process more uniform, more consistent, less prone to human error, and faster.

It would be advantageous to have a clamp and clamping process designed for automated and robotic assembly.

It would be advantageous to have a clamp and clamping process not requiring the insertion of two or more wire elements into a circular opening.

It would be advantageous to have a clamp and clamping process not requiring a calculation or estimate of the ratio between the claim, the clamp opening, and the object to be clamped not subject to human estimation, selection, and error.

It would be advantageous to have a clamp and clamping process allowing for a range of diameters of wire harnesses or looms.

It would be advantageous to have a clamp and clamping process designed to be optimized by computer processes for the precise calibration of pressure.

It would be advantageous to have a clamp and clamping process principally employing high performance plastic and/or heat resistant plastic.

It would be advantageous to have a clamp and clamping process principally employing plastic with known, specialized, or controlled deformation qualities to ensure uniform radial clamping pressure throughout a 360-degree circumference.

It would be advantageous to have a clamp and clamping process containing a guide rail or rails with a hinged portion establishing by a calibration in the manufacture of that rail(s) a range of pressure required for the insertion of a male intrusion into a female slot.

It would be advantageous to have guide rails principally employing plastic with known, specialized, or controlled deformation qualities to ensure guide rails can be pushed out of the slotting channel by a calculated pressure. or the depressible tongue can be depressed by a calculated pressure.

It would be advantageous to have a clamp and clamping processing employing a swinging rotation arm and cup to receive an upper or lower clamp to apply to a wire loom or harness.

It would be advantageous to have in a clamp and clamping processing employing a swinging rotation arm and cup to receive an upper or lower clamp to apply to a wire loom or harness to have a break away thread aligning an upper or lower in the feeding mechanism or one or more holes in each female half clamp and male half-clamp to allow a push pin to separate one clamp form the next clamp.

It would be advantageous to have a clamp and clamping processing employing an in line feeding mechanism of an upper or lower clamp to apply to a wire loom or harness.

It would be advantageous to have a tubelike sleeve for stacks of each of the female and male clamp parts whereby each half of the clamp might be fed successively and repeatedly to enclose the wire harness or loom or the pipe or pipe nipple and hose.

It would be advantageous to have for stacking and feeding purposes both the male and female half of the clamp would have each two male posts on either side to fit partially into the two domes of the clamp above, and two concave domes on either side to partially receive the two male posts of the clamp below. By only partially inserting the two posts into the two concave domes above, space is maintained in the stack between each male half clamp and each female half clamp such that machine forks, plates, on tongues for applying pressure or for handling might be inserted into that space between each half-clamp.

It would be advantageous to have one or more holes in each clamp whereby small pins or pistons might push each clamp to release from the stack.

It would be advantageous in a clamp and clamping processing employing an in line feeding mechanism of an upper or lower clamp to apply to a wire loom or harness to have a break away thread aligning an upper or lower in the feeding mechanism.

It would be advantageous to have a clamp and clamping process containing a guide rail or rails with a hinged portion establishing by a calibration in the manufacture of that rail(s) a range of pressure required for the insertion of a male intrusion into a female slot with a finer calibration of pressure determined by one or more pressure plates in the force-employing arms utilizing a computer feed-back loop to determine the clamping pressure.

Alternatively, it would be advantageous to have a clamp and clamping process where as an alternative to two guide rails there is one hinged flexible tongue originating in the upper portion of the lower clamp and descending less than the full width with the female slots not extending across the whole width but having the center taken by the tongue.

It would be advantageous to have a tongue that can be depressed cut into the upper half of the female, above or below the plane of the of the female inner circumference, to guide and modulate the pressure interaction between the passive resistance 600 of the object and the male protrusions 100 and guide rails.

It would be advantageous to have a clamp and clamping process containing a guide rail or rails that overhang with a convex curved inner side/edge the slotting channel in order that the trapezoidal male protrusion may force it out of the slotting channel.

It would be advantageous to have guide rails with a convex inner edge that when being pushed down by the trapezoidal edge of the mail protrusions would push over to lay flatter and allow the male protrusions to continue descending into the slotting channel.

It would be advantageous to have a clamp and clamping process principally employing high performance plastic not susceptible to deformation by hot or cold temperatures.

It would be advantageous to have a tool for a clamp and clamping process with a computer-controlled sensor and feedback mechanism for applying pressure through the operating arms.

It would be advantageous to have a tool for a clamp and clamping process with a pressure reading device that can be used in the field.

It would be advantageous to have an automated clamp and clamping process designed to be easily integrated into an assembly line.

It would be advantageous to have a two-part two half circle clamp to allow more flexibility in the automated placement and application of a clamp in an assembly line or robotic process.

It would be advantageous to utilize a precise series of incremental slots to achieve a calibration of an exact intended closing circumference.

It would be advantageous for a clamp to have a pressure feedback mechanism allowing for the application of a secondary or tertiary clamp of varying pressure.

It would be advantageous in a clamp to have a variable circumference.

It would be advantageous in a clamp to have guide rails that can flatten to allow a male protrusion and a female slot to lock.

It would be advantageous in a clamp to have guide rails that can flatten to allow male protrusions 100 and female slots to lock at a certain point of passive resistance 600.

It would be advantageous if the thickness of the guide rails in the female half clamp grows thinner toward the lower part of the female half clamp in order to decrease the force necessary to make that portion of the guide rail lay over flat.

It would be advantageous if the height of the guide rails in the female half clamp may diminish in height toward the lower part of the female half clamp in order to decrease the force necessary to make that portion of the guide rail lay over flat.

It would be advantageous if the male protrusions in the male half clamp were of an upside down isosceles trapezoidal shape, with the sides slanting inward down toward the center such that as they are pushed down into the channel the increasing width of the protrusions force the guide rails outward to lay over flatter.

It would be advantageous if the increasing with of the male protrusions in the male half clamp as it is pushed downward into the slotting channel pushed against the upper part of a convex rail inner side causing the guide rail to lay over flatter.

It would be advantageous in a clamp to having guide rails that can flatten to allow male protrusions and a female slot to lock at a certain point of passive resistance to have a hinge area of that rail that might be adjusted as to strength and flexibility to set a range of passive resistance.

It would be advantageous for the female half clamp to have one or more tab extensions that can be pushed to open the clamp.

Alternately, the two half clamps can be joined by a hinge on one side, and with the protrusions on only one side of the male half-clamp, and the female slots on only one side of the female half-clamp.

### SUMMARY OF THE INVENTION

The present invention relates to new article of manufacture, a machine, and a process for automatically, circumferentially, sequentially, and repeatedly in an assembly line clamping articles which extend in the axial direction, in particular cable and wiring harnesses and looms, and pipe, pipe nipples and hoses. by use of opposing pressure-controlled pistons pushing a male half-circle clamp locking into a female half-circle clamps to achieve a lock, which could in some embodiments be at a desired pressure level or desired circumference.

The invention is a two-part circular clamp and clamping process for surrounding and overlapping a join of a fluid hose on a pipe, barb, or nipple, or for clamping multiple tubes or electrical wires and cables or using a dual compression arm on an in-line assembly, or for wrapping coiled electric cords.

The clamp comprises a half-circle male element with male protrusions 100 inserted into a half-circle female element with slots 200 for the male protrusions 100.

The slotting is achieved by pushing the two leading edges of the male element along two parallel rails 700 decreasing in height and thickness on the inner circumference of the female elements until the rail level merges with the inner circumference caused by the passive resistance 600 of the object to be clamped and the compression delivered by the compression arms.

Each guide rail intrudes into the vertical air space immediately above the slot initially preventing male protrusions 100 from descending until sufficient force causes guide rail to be pushed out of the vertical air space by protrusions 100 with outer side edges angled inward in male half clamp allowing slotting.

The two rails 700 in the female half clamp can also be laid over horizontally or pushed back by the force of a male protrusion out of the channel transverse width of the female slots 200 given sufficient force allowing an earlier insertion on the circumference of the male element into the female element prior to the end of the rail.

The force required to cause the guide rail 700 to lay flat may be initially calibrated into the hinged area of the rails 700 of the manufactured two-part clamp to achieve an approximate range of passive resistance 600 to the clamping force to determine the final pressure of the clamp on the object clamped.

Alternately, the width between the rails 700 may widen to allow the male protrusions 100 to descend into the female slots 200.

A depressible tongue 1300 in the female half clamp less than the width of the clamp may assist in the modulation and timing of the force applied allowing for the male protrusions 100 to slot into the female slots 200.

A clamping machine comprising a tubelike sleeve for stacks of each of the female and male clamp parts whereby each half of the clamp might be fed successively and repeatedly to enclose the wire harness or loom or the pipe or pipe nipple and hose or coiled electronic cord. The clamps are fed through a stack of the male half clamp and a stack of the female half clamp in tubelike sleeves for each of the female half clamp and the female half clamp.

For stacking and feeding purposes both the male and female half of the clamp would have each two male posts on either side to fit partially into the two concave domes of the clamp above, and two concave domes on either side to partially receive the two male posts of the clamp below. By only partially inserting the two posts into the two concave domes above, space is maintained in the stack between each male half clamp and each female half clamp such that machine forks, plates, on tongues for applying pressure or for handling might be inserted into that space between each half-clamp.

One or more holes in each clamps enables small pins or pistons to push each clamp to release from the stack as the two halves are pressed together to interlock.

The invention is used in the field of clamping wire looms and cable harnesses for the automotive, boating, electronic, aerospace, and space industries, and fastening hose onto pipes and pipe nipples.

Cable harnesses are often used in automobile construction. A cable harness is a loom of cables which transmit signals or information or operating currents (energy). The cables are combined, for example, by clips, cable binders or tubes. Modern motor vehicles may have electrical wires which, in total, can reach several kilometers.

The present invention comprises a physical compression device, computer hardware, and a computer software process for clamping and harnessing in an automated or robotic assembly in manufacturing.

The elements of the present invention comprise a physical male clamp element, a physical female clamp element, descending guide rails 700 in the inner circumference of the female element and may include a hinged depressible tongue 1300 within the circumference of the female clamp half, one or more compression force arms 000, 900, a pressure reading mechanism, a pressure feedback mechanism, a pressure applying mechanism 400, pressure computation 1200, a calibration 1000 mechanism, computer hardware, and a computer loop process 1200 to adjust and achieve the desired pressure.

The physical male element comprises an approximate half circle with protruding male elements on the outer circumference with angled inward side edges designed for general insertion into a receiving female element. The protruding elements are designed to be inserted into the female slots 200 of the receiving female element.

The physical female element comprises an approximate half circle with multiple receiving slots 200 for the male element allowing multiple final locking positions, and descending guide rails 700 to enable the male element to achieve the maximum depth into the circumference of the female elements. The guide rails 700 are designed to lay over horizontally when force by the passive resistance 600 of the object to be clamped or enclosed, or designed not parallel but expanding outward.

The compression force arms, one above and one below, cause the male approximate half circle element to be pressed into the female approximate half circle element. The male element slides on top of the descending height guide rails 700, which prevent the premature insertion of the male element into the female element until the circumference of the combine lower female element and upper male element more tightly enclose or wrap the enclosed object. In some cases, a sufficient force will cause the lower portion of the circumference of the descending height rails 700 to lay over horizontally, allowing the mail element to penetrate the female slots 200.

A tongue 1300 that can be depressed cut into the upper half of the female, above or below the plane of the of the female inner circumference, part to guide and modulate the pressure interaction between the passive resistance 600 of the object and the male protrusions 100 and guide rails 700 may assist in the layover of the guide rails 700 as the male protrusions 100 sink into the female slots 200.

The thickness of the guide rails 700 in the female half clamp may grow thinner toward the lower part of the female half clamp in order to decrease the force necessary to make that portion of the guide rail lay over flat.

Each guide rail 700 intrudes into slot space over the female slots 200 preventing the male protrusions 100 from descending until sufficient force causes guide rail to be pushed out of slot channel allowing slotting.

Where the guide rails 700 join the inner radius of the clamp the width of the raise is thinner to allow hinge-like action.

The plane of rail guide curvature intersects with the male protrusions 100 to enable the downward force of the mail protrusions 100 as the male protrusions 100 are compressed between the female half clamp and the object to be wrapped to move the rail guide aside.

The height of the guide rails 700 in the female half clamp may diminish in height toward the lower part of the female half clamp in order to decrease the force necessary to make that portion of the guide rail lay over flat.

The height of the guide rails 700 in the female half clamp may diminish in thickness toward the lower part of the female half clamp in order to decrease the force necessary to make that portion of the guide rail lay over flat.

The guide rail or rails 700 overhang with a convex curved inner side the slotting channel in order that the trapezoidal male protrusion may force the rails 700 out of the slotting channel.

The guide rails 700 have a convex inner edge that when being pushed down by the trapezoidal edge of the mail protrusions 100 causes the guide rail to push over to lay flatter and allow the male protrusions 100 to continue descending into the slotting channel.

The clamp and clamping process principally may employ high performance plastic not susceptible to deformation by hot or cold temperatures.

The clamp halves are made of plastic with known, specialized, and controlled deformation qualities to ensure uniform radial clamping pressure throughout a 360-degree circumference.

The guide rails 700 contain a hinged portion establishing by a calibration 1000 in the manufacture of that rail(s) a range of pressure required for the insertion of a male protrusion 100 into a female slot 200.

The guide rails 700 are made of plastic with known, specialized, or controlled deformation qualities to ensure guide rails 700 can be pushed out of the slotting channel by a calculated pressure.

The depressible tongue 1300 is made of plastic with known, specialized, or controlled deformation qualities to ensure the tongue 1300 can be depressed by a calculated pressure.

As the upper male and lower female elements compress the object to be enclosed, that object's passive resistance 600 causes an increase in pressure. The pressure sensor 910 informs the computation 1200 element, and a looped computer process assists in the application of force until the desired pressure is reached.

A pliers-like tool with or without a pressure gauge may be used to compress and interlock the male and female half clamp.

The dual compression arm assembly can be manual, automated, or robotic. A computer software computation 1200 program comprising a pressure sensor 910 inside the circumference of the compressing face of pressure arms provides continuous feedback reporting 1100 to the pressure mechanism calibrating 1000 the pressure to apply to one more of the compression arm ends.

The male half clamp and female half clamp comprise a circumferential compression slide lock clamp with pressure calibration 1000 and feedback 1100. Point of insertion can be accomplished by passive resistance 600 or a computer feedback loop 1200 for in-line continuous assembly.

A continuous control loop for pressure calibrations 1000 and application enabling precise pressures to be uniformly applied in clamps for in-line continuous assembly of clamps securing hoses over barbed and bibbed insertion connections, which is also suited where w-cross section O-rings or Belleville springs are utilized as the innermost ring surrounding the connection.

The invention includes on the female half clamp on the end point of the opposite sides one or more-tab extensions that can be pushed to open the clamp.

### BRIEF DESCRIPTION OF THE DRAWINGS

FIG. 1 is a drawing showing master view of the two-part clamp, clamping process, pressure sensors, depressible tongue, guide rails, male protrusions, female slots, and computer-controlled pressure arms 000, 900 with pressure calibration 1000 and feedback loop 1000, 1100, 1200.

FIG. 2 is an expansion view of alternate male protrusion 100 and alternate slotted female slot 200.

FIG. 3 is An Expanded Side View Of Descending Layover Guide Rails 700 And Slotting.

FIG. 4A Top View of Layover Guide Rails 700 Enabling Slide Over and

FIG. 5 Top View of Layover Guide Rails 700 Enabling Forced Over Rails To Enable Slotting and Front Cut-Away of Rail Guide System

FIG. 6 is a drawing showing Side Swinging Compression Arms or Alternate Upper and Lower Compression Arms

FIG. 7 is a drawing showing Side View of Forced Layover for Second Position (Closed) Slotting

FIG. 8 is a drawing showing Vertical Expansion Showing Male Slotting Mechanism for Third Position (Closed)

FIG. 9 is a drawing showing Vertical Expansion showing an Alternate Tooth Rachet Locking mechanism (Third position, closed)

FIG. 10 is a drawing showing a Third Position Expanded View of Rail Descent for Third Position Slotting

FIG. 11 is a drawing showing Rotational Swinging Upper Clamp Feeding Mechanism

FIG. 12 is a drawing showing a Rotational Swinging Lower Clamp Feeding Mechanism

FIG. 13 is a drawing showing an In Line Upper and Lower Clamp Feeding Mechanism

FIG. 14 is a drawing showing Supporting Guide Tongue 1300 Inner Top End View FIG. 15 is a drawing showing the Supporting Guide Tongue 1300 Side View

FIG. 16 is a drawing showing the Supporting Guide Tongue 1300 Inner Lower Clamp Upper Portion Top View

FIG. 17 Shows a drawing of Stacked Half Clamps with Pins

FIG. 18 Shows an Alternate Male and Female Locking on One Piece Clamp

FIG. 19 Shows Flowchart of Computerized Pressure Management for Pressure Arms

FIG. 20 Shows Flowchart of Male and Female Half Clamp Pressurized Locking Process

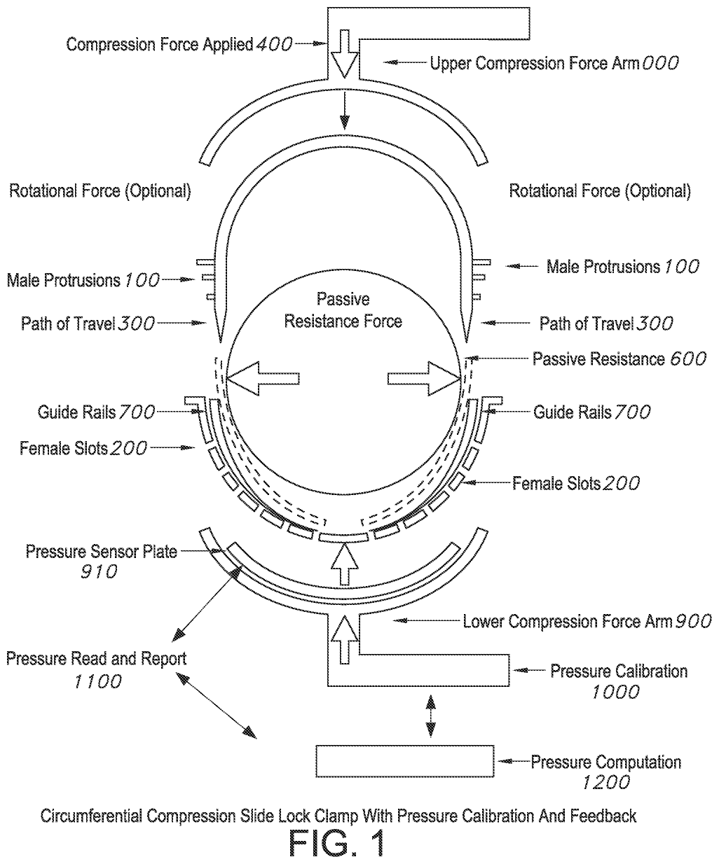

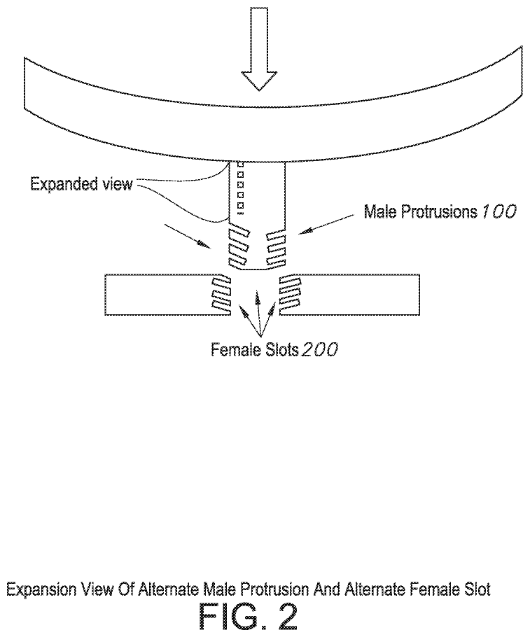

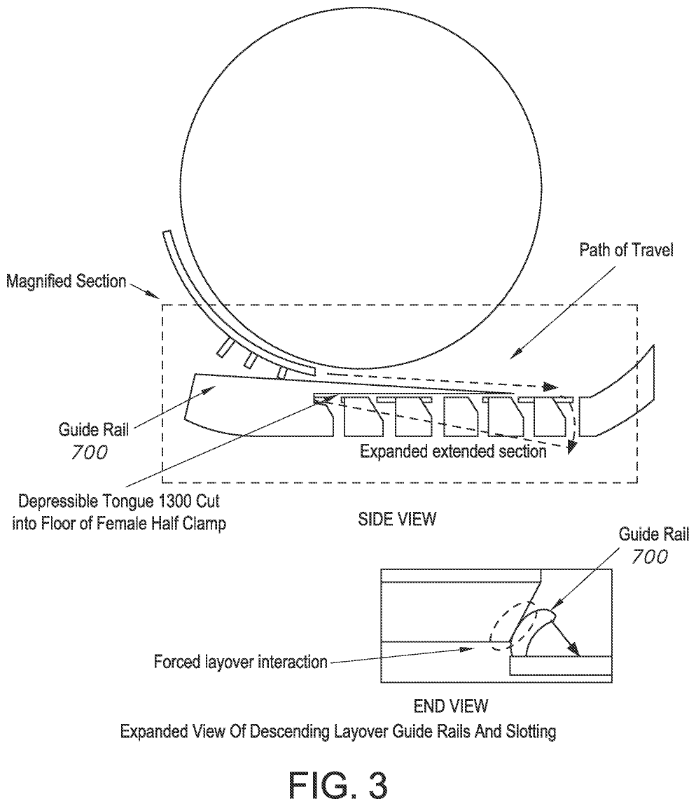

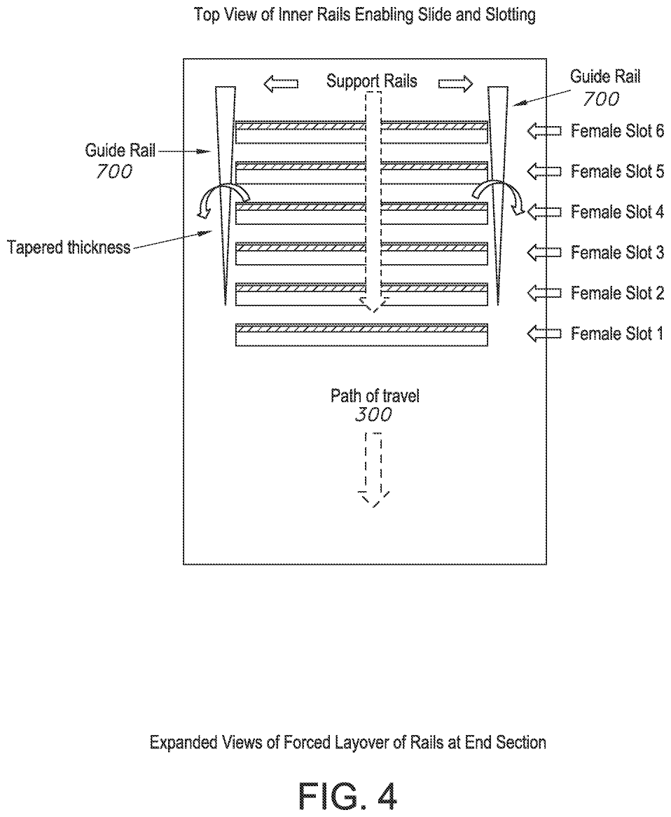

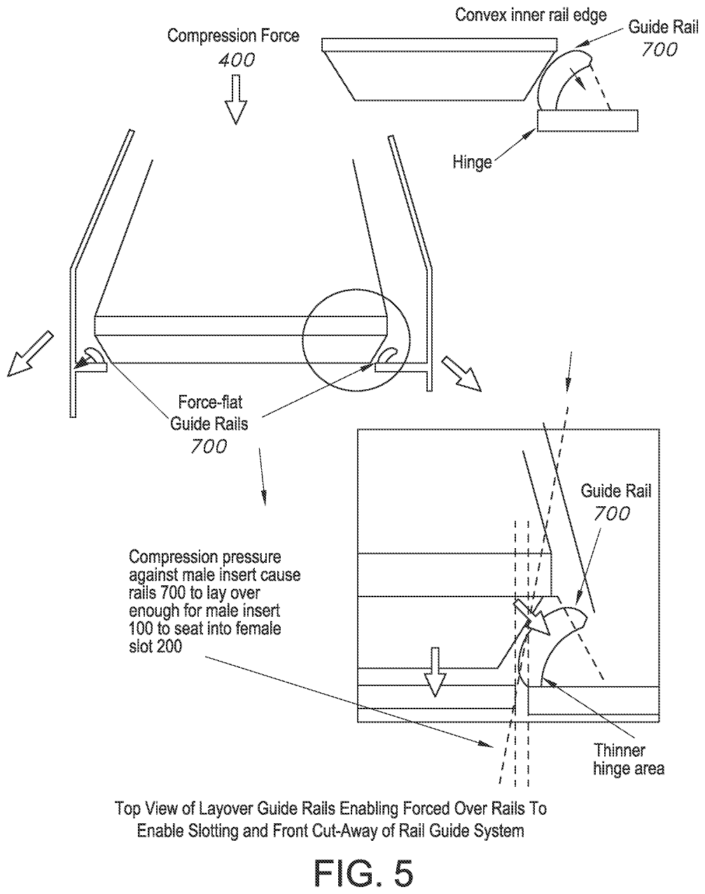

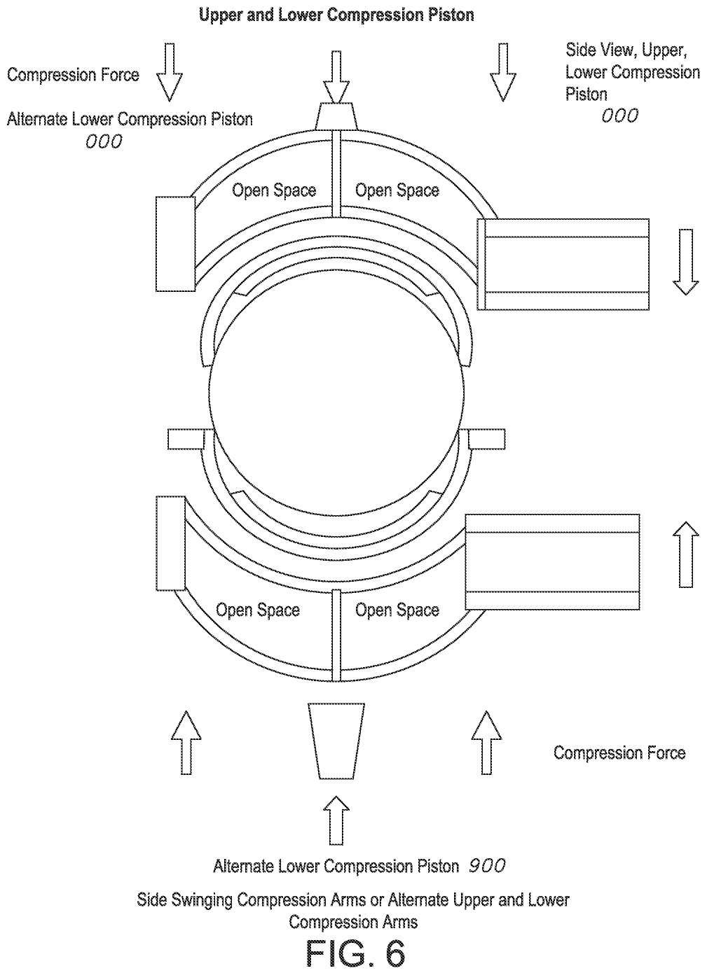

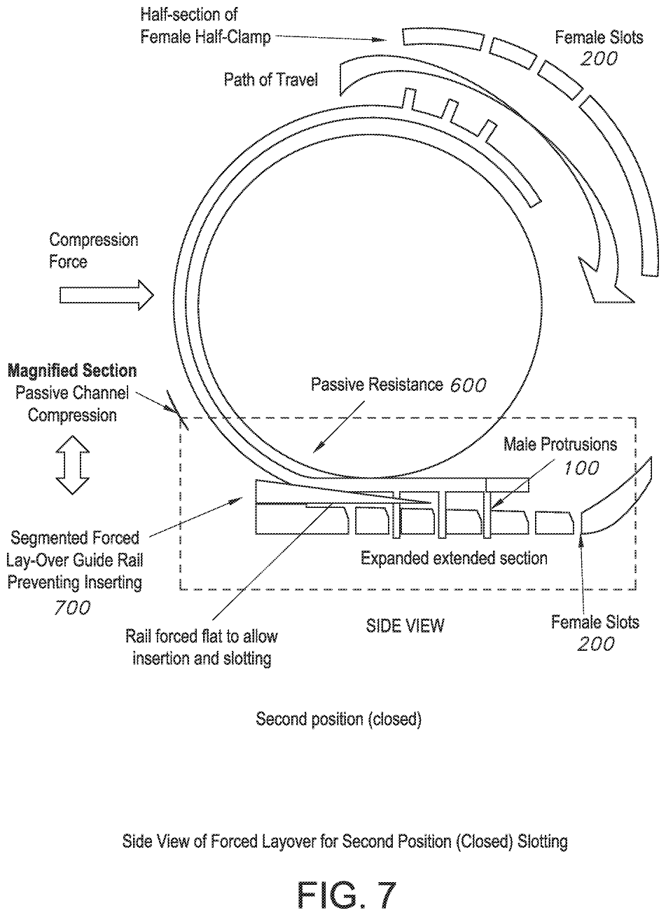

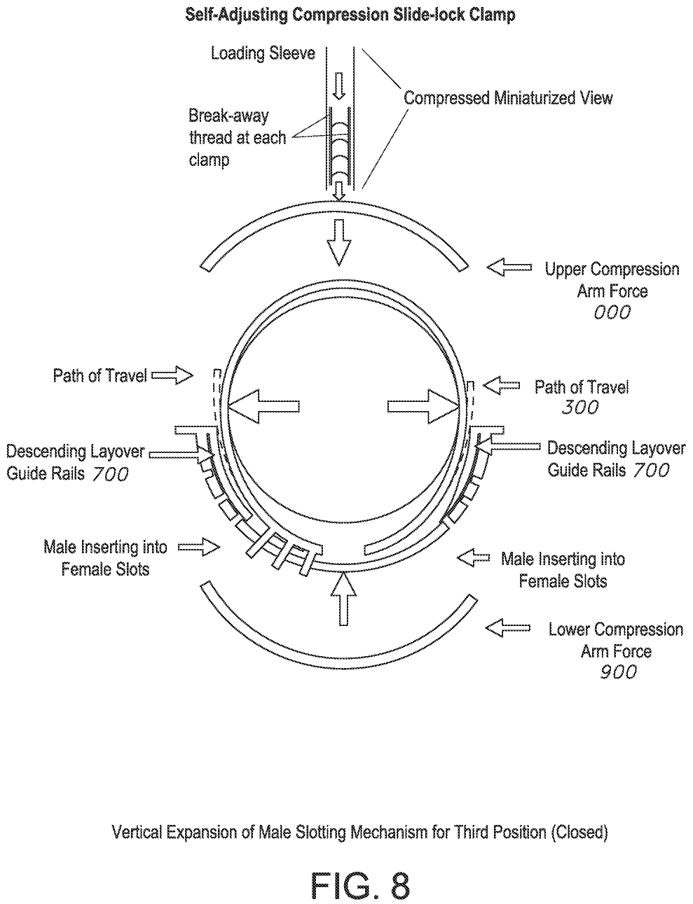

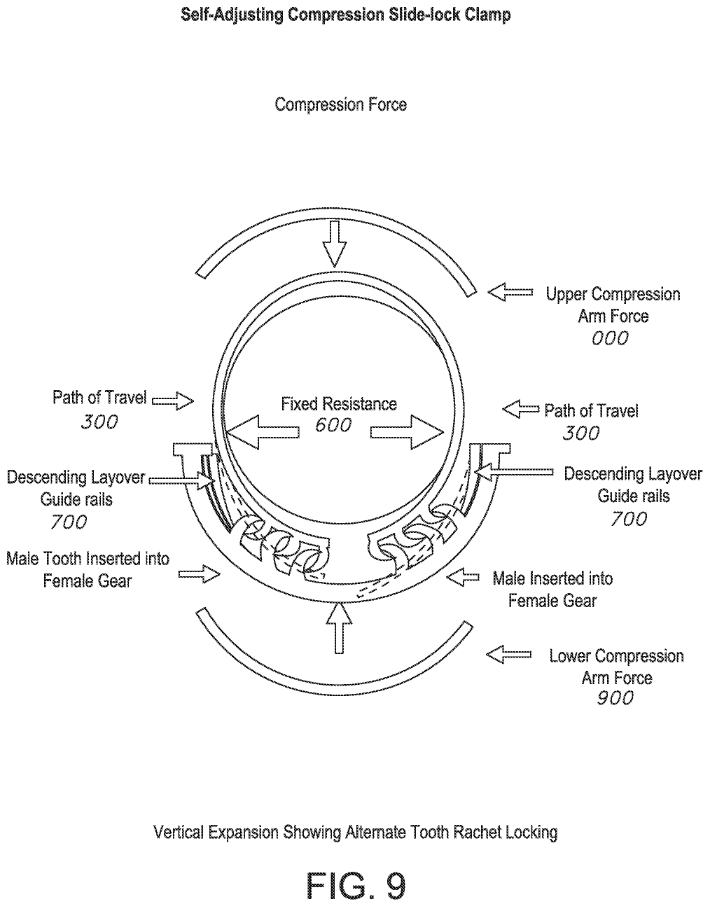

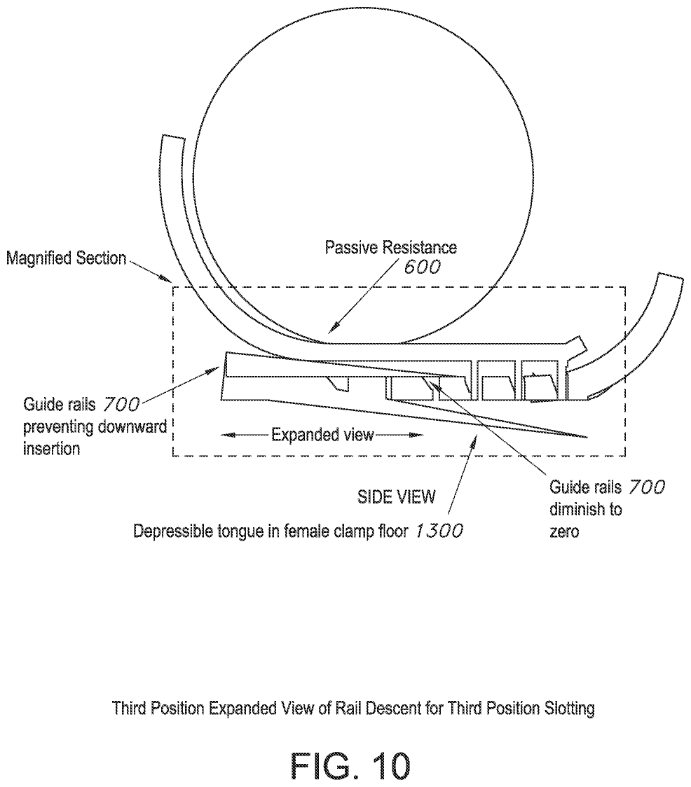

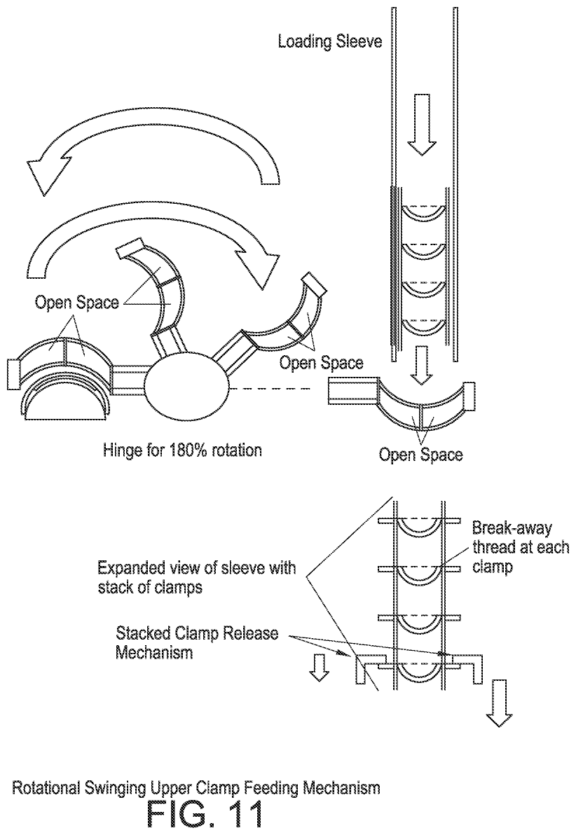

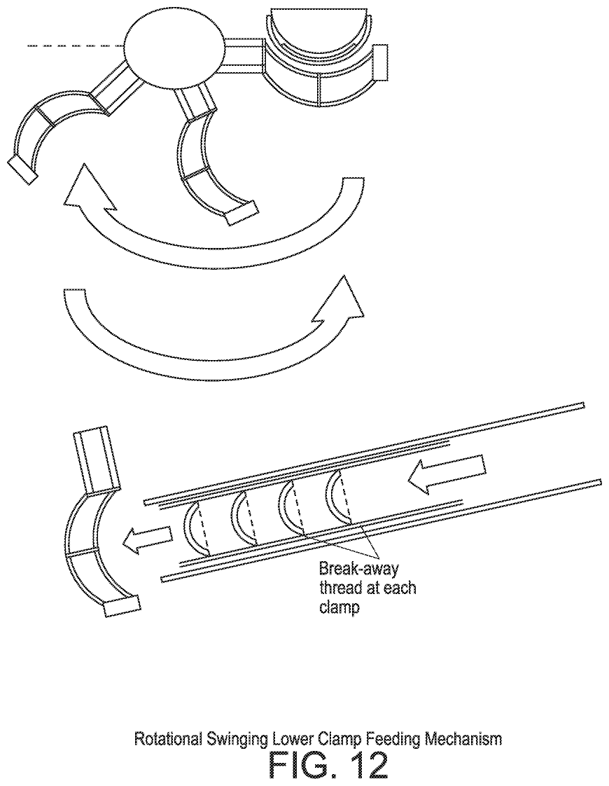

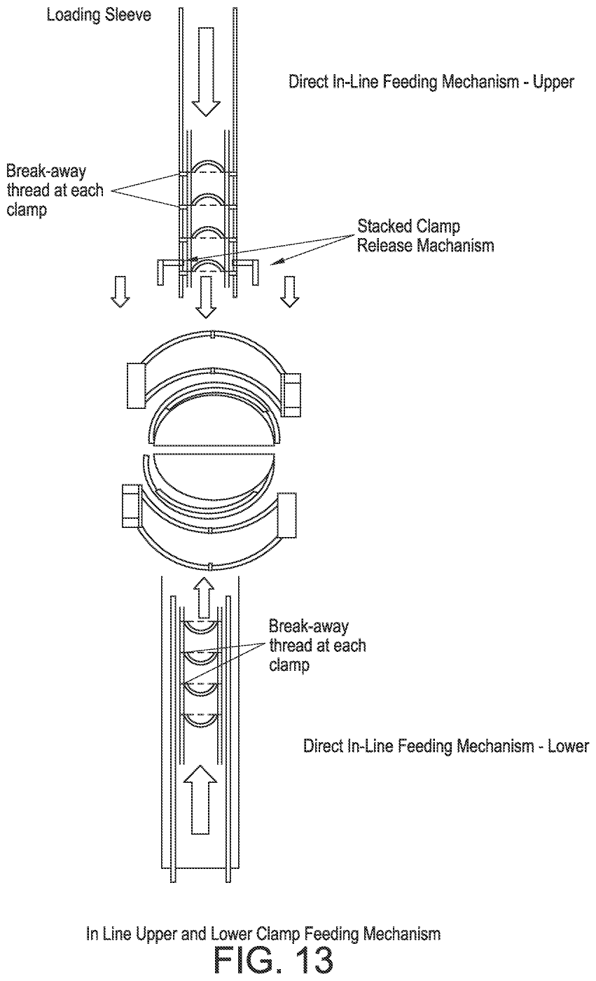

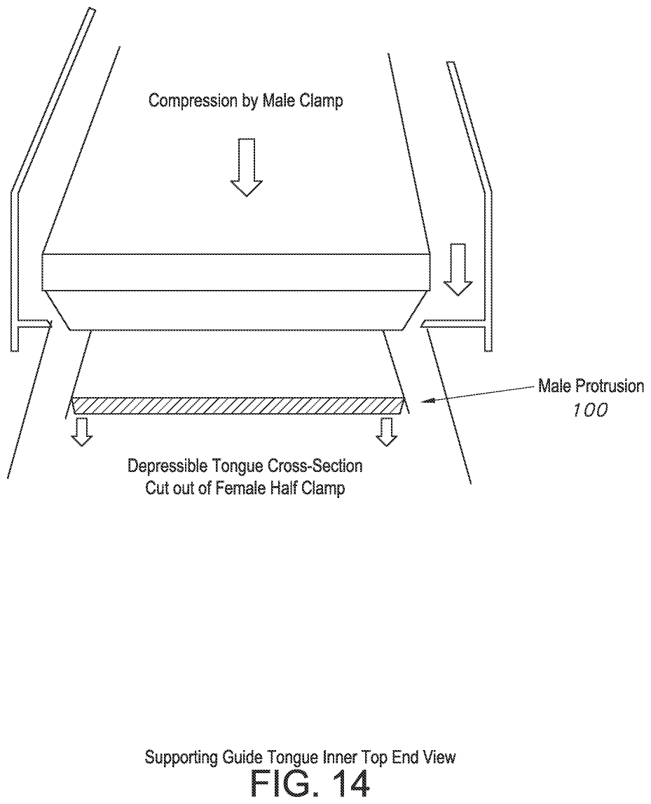

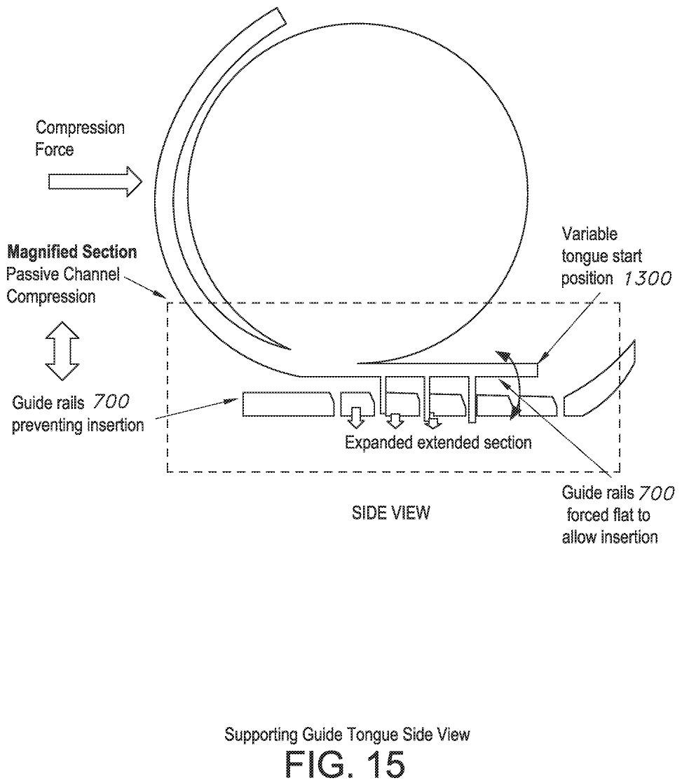

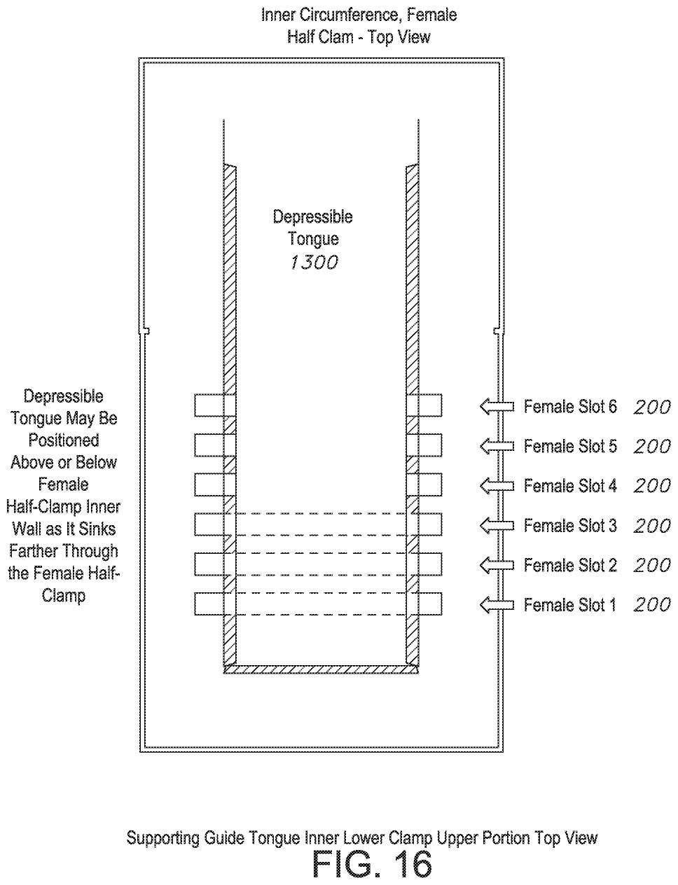

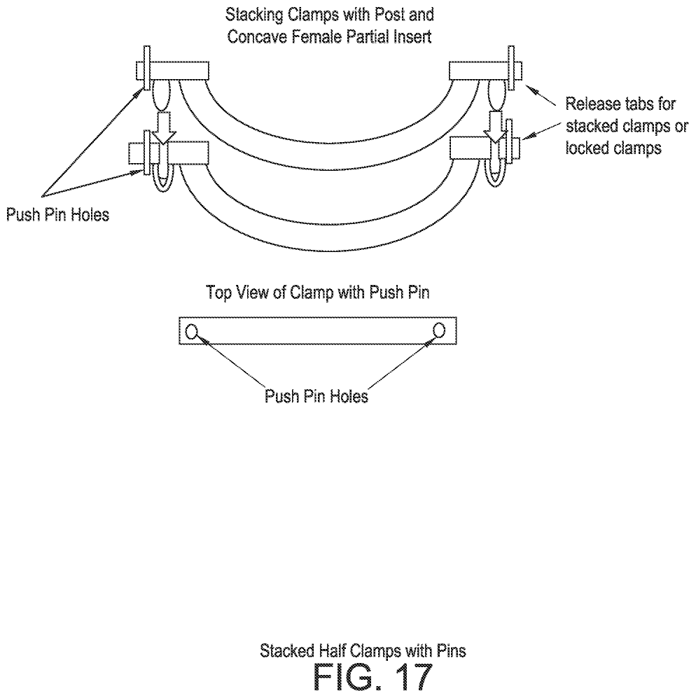

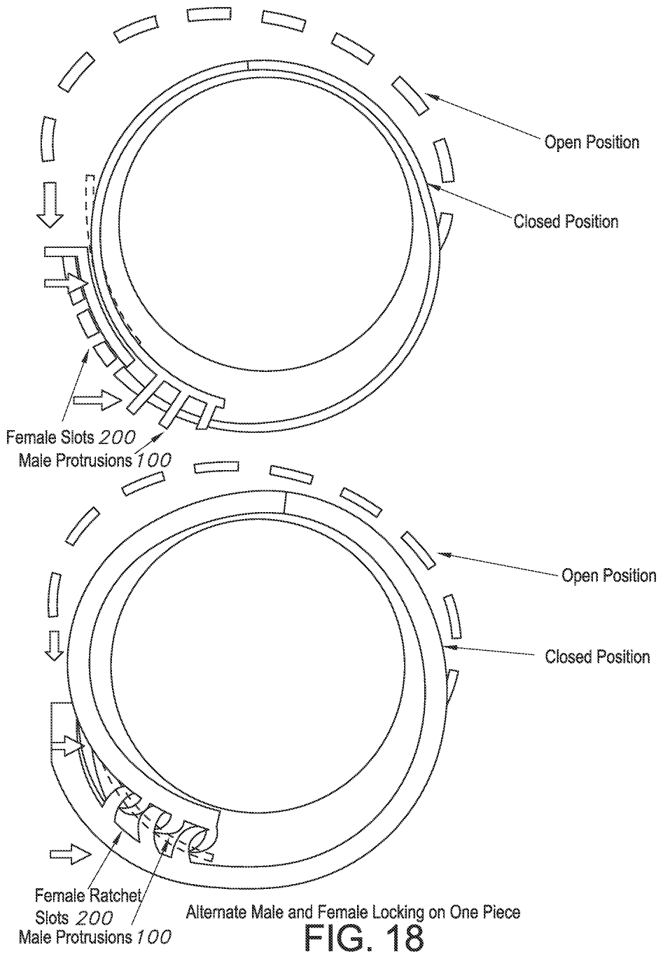

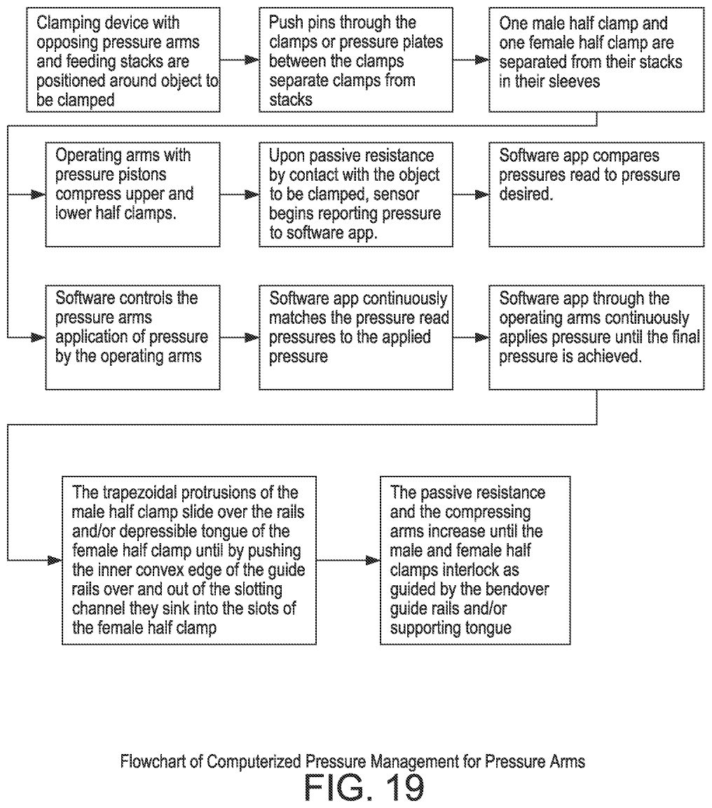

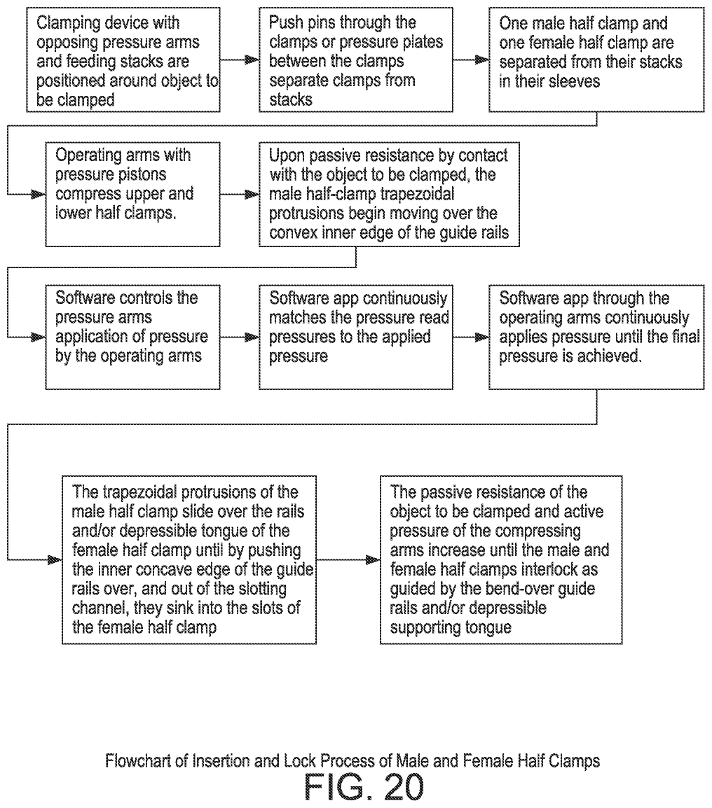

### DESCRIPTION OF THE PREFERRED EMBODIMENT

In the preferred embodiment an upper half-circle clamp with male protrusions 100 on the lower third inner radius of each side is mated to a lower half-circle clamp with female slots 200 on either side in the center third inner circumference to encircle a wire harness or loom, or a male pipe or pipe with a nipple, and a female tube, or a coiled electronic power cord.

For stacking and feeding purposes both the male and female half of the clamp would have each two male posts on either side to fit partially into the two concave domes of the clamp above, and two concave domes on either side to partially receive the two male posts of the clamp below. By only partially inserting the two posts into the two concave domes above, space is maintained in the stack between each male half clamp and each female half clamp such that machine forks, plates, on tongues for applying pressure or for handling might be inserted into that space between each half-clamp.

The invention includes on the female half clamp on the end point of the opposite sides one or more-tab extensions that can be pushed to open the clamp.

The clamping device positions opposing pistons around the object to be clamped. Pins push through the clamps or pressure plates between the clamps to separate the clamps from the stacks of half-clamps positioned to supply the clamping device.

Alternately, a tab may be inserted between the clamp tabs in order to push the clamp down in preparation of applying pressure to lock the upper and lower part.

A pressure piston 900 pushes the half-circle male clamp part into the female half-circle male part, and a pressure piston may hold or push the female part against the mail part.

A pressure sensor 910 on the inner radius of one or both half-clamps begins reporting 1100 pressure to a computer software app.

The pressure is controlled by reading in a computer-controlled feedback loop 1000, 1100, 1200 a pressure sensor 910 on the inner circumference of the male and female clamp halves where it comes into contact with the wire harness, wire loom or tube, around a pipe or pipe nipple electronic power cord as the passive resistance 600 of the article to be clamped meets the thrust 400 of the male and female pistons 000 driving the male and female half clamp parts to close by inserting the male protrusions 100 into the upper half clamp into the female slots 200 in the lower half-clamp.

A hardware and software loop 1000, 1100, 1200 controls the pressure 400 applied to the forces arms to compress the upper and lower clamp together into a locked position. A feeder mechanism with a chain of clamp halves linked together with a break-away thread supplies the upper half male clamp and the lower half female clamp with each clamping cycle with the thread breaking away to release the upper and lower clamp halves to form one interlocked clamp.

Alternately, in a clamp and clamping processing a feeding mechanism pushing pins through one or more holes in each female half clamp and male half-clamp allows a push pin to separate one clamp form the next clamp in stacks of clamps.

Operating arms compress the upper and lower half clamps with passive resistance 600 as contact with the clamped object. The software app utilizing a sensor 910 compares pressures read 1100 to pressure desired 1000, 1200.

Software 1000, 1100, 1200 controls the pressure 400 arms' application of pressure by the operating arms 000, 900, with a software app continuously matching the pressure read pressures from the pressure sensors 910 to the pressure desired 1000, 1100, 1200. The software app through the operating arms 000, 900 continuously applies pressure 400 until the final pressure calibration 1000 is achieved.

The protrusions 100 of the. male half clamp slide over the rails 700 and depressible tongue 1300 of the female half clamp until they sink into the slots 200 of the female half-clamp.

The tangent line of guide rail 700 curvature intersects with male protrusions 100 to enable force to move rail guides 700 aside.

The passive resistance 600 and the compressing arms 000, 900 increase until the male and female half clamps interlock as guided by the bend-over guide rails 700 and/or supporting tongue 1300.

The moving compressing male part moves between the passive resistance 600 of the object to be clamped and the female half clamp.

The male half clamp rides down the rails 700 and tongue 1300 of the female clamp until the mail protrusions 100 can descend into the female slots 200.

The male protrusions 100 on the male upper claim part are guided by parallel rails 700 and/or a flexible tongue 1300, preventing the male half-clamp protrusions from descending and slotting into the slots 200 of the female lower clamp part, until the pressure of the thrusting force elements upper and lower meet a programmed or maximum threshold. The rails 700 or tongue 1300 keep the male upper clamp within the inner circumference of the female circular half until sufficient force forces the guide rails 700 flat allowing the male protrusions 100 to sink and seat into the female slots 200 and/or depress the tongue 1300 outward to allow the male protrusions 100 to sink and seat into the female slots 200.

Alternately, the guide rails may not be parallel, but moving outward as they descend, allowing the male protrusions 100 to sink into the female slots 200.

The physical male element comprises an approximate half circle with protruding male elements on the outer circumference and angled side edged designed for general insertion into a receiving female element. The protruding elements are designed to be inserted into the female slots 200 of the receiving female element.

The physical female element comprises an approximate half circle with multiple receiving slots 200 for the male protrusions 100 allowing multiple final locking positions, and descending guide rails 700 to enable the male protrusions to achieve the maximum depth into the female elements into arc of the circumference. The guide rails 700 are designed to lay over horizontally when force by the passive resistance 600 of the object to be clamped or enclosed.

The compression force arms, one above 000 and one below 900, cause the male approximate half circle element to be pressed into the female approximate half circle element.

The male protrusions 100 slide on top of the descending height guide rails 700, which prevent the premature insertion of the male protrusions 100 element into the female slot 200 element until the inner circumferences of the combined lower female element and upper male element more tightly enclose or wrap the enclosed object.

In some cases, compression pressure pushing the male protrusions 100 will cause the lower portion arc of the circumference of the descending height rails 700 to lay over horizontally, allowing the mail element to seat into the female slots 200.

A tongue 1300 that can be depressed cut into the upper half of each side of the female clamp, above or below the plane of the of the female inner circumference, to guide and modulate the pressure interaction between the passive resistance 600 of the object and the male protrusions 100 and guide rails 700 may assist in the layover of the guide rails 700 as the male protrusions 100 sink into the female slots 200.

The thickness of the guide rails 700 in the female half clamp may grow thinner toward the lower part of the female half clamp in order to decrease the force necessary to make that portion of the guide rail 700 lay over flat.

Each guide rail 700 intrudes into slot space preventing male protrusion from descending until sufficient force causes guide rail to be pushed out of slot channel allowing slotting.

Where the guide rail 700 joins the inner radius of the clamp the width of the rail corresponds to the calculated force required to lay over the rails 700 by allowing hinge-like action.

The tangent line of the convex inner edge of the rail guide curvature intersects with male protrusion to enable the pressure force to move rail guide aside.

The height of the guide rails 700 in the female half clamp may diminish in height and or thickness toward the lower part of the female half clamp in order to decrease the force necessary to make that portion of the guide rail lay over flat.

As the upper male and lower female elements surround and compress the object to be enclosed, pushing the leading edges of the male clamp into the receiving leading edges of the female clamp around that object, that object's passive resistance 600 causes an increase in pressure between the male and female elements. The pressure sensor 910 informs 1100 the computation 1200 element, and a looped computer process 100, 1100, 1200, assists in the application of force until the desired pressure is reached.

A pliers-like tool with or without a pressure gauge may be used to compress and interlock the male and female half clamp.

The dual compression arm assembly 000, 900, can be manual, automated, or robotic. A computer software program comprising a pressure sensor 910 inside the circumference of the compressing face of pressure arms provides continuous feedback to the pressure mechanism calibrating the pressure to apply to one more of the compression arm ends.

The dual compression arms have an open center channel to allow for the male protrusions 100 to pass through when being compressed.

Point of insertion can be accomplished by passive resistance 600 or a computer feedback loop 1000, 1100, 1200 for in-line continuous assembly applying a pressure force 400 through compression arms 000, 900.

A continuous control loop 1100 for pressure calibrations 1000 and application 1200 enabling precise pressures to be uniformly applied in clamps for in-line continuous assembly of clamps securing hoses over barbed and bibbed insertion connections, which is also suited where w-cross section O-rings or Belleville springs are utilized as the innermost ring surrounding the connection.

The invention includes on the female half clamp one or more-tab extensions that can be pushed to open the clamp.

The clamp halves may be injection molded or 3-D printed plastic. A programmable chip or FPGA may be integrated into the invention for the setting and determination of the application of the pressure by the compression arms as reported 1100 back by the pressure sensors 910.

The pressure on either side may also be generated manually by a pliers-like tool with or without a pressure sensor 910, with or without a means to calibrate 1000 a pressure.

The invention includes on the female half clamp one or more-tab extensions that can be pushed to open the clamp.

While the present invention has been described with reference to certain preferred embodiments, those skilled in the art will recognize that various modifications, refinements, calibrations, alternate fabrication materials or combination of materials, means of manufacturing the device, means of clamping the device, means of feeding the clamp stacks into the clamping mechanism may be provided to achieve the same invention(s).

What is claimed is:

1. A clamping device comprising:
a semicircular male clamp capable of fitting partially within
a semicircular female clamp;
the male clamp having at least one protrusion on its outer circumference;
a semicircular female clamp with at least one receiving slot on its inner circumference; and
parallel guide rails on the inner circumference of the female clamp forming a trough;
the at least one protrusion being attached to the outer circumference of the male clamp and sized to fit the trough and the at least one receiving slot.

2. The apparatus of claim 1, further comprising a depressible tongue cut into the floor of the female clamp, said depressible tongue running parallel to the circumference of the female clamp with one end of said depressible tongue attached to the floor of the female clamp.

3. The apparatus of claim 1, wherein at least one of the male or female clamps has one or more pressure sensors.

4. The apparatus of claim 2, wherein the one or more pressure sensors are connected to a computer monitoring the pressure applied to the one or more pressure sensors.

5. The apparatus of claim 1, wherein the male protrusion on at least one side has at least one outward facing spine-like protrusion and the female locking clamp on at least one side of the female slot has at least one female slot.

6. The apparatus of claim 1, wherein both ends of the at least one protrusion on the male clamp is cut at an angle other than a right angle.

7. The apparatus of claim 1, wherein the end of the at least one protrusion on the male clamp has angular sides sloping inward toward the unattached side from the attached side, said at least one protrusion being capable of pushing down and over at least one of the guide rails.

8. A method for clamping, comprising:
applying pressure to a clamp comprising an opposing half-circular male and a half-circular female clamp;
and pushing at least one male protrusion on the outer circumference of the male clamp through parallel guide rails forming a trough on the inner circumference of the half-circular female clamp until at least one protrusion in the male clamp is able to sink into at least one slot in the half-circular female clamp.

9. The method of claim 8, wherein the parallel guide rails are descending in height, and the at least one male protrusion rides atop the rails.

10. The method of claim 8, wherein the pressure causes the protrusions on the male clamp to cause a depressible tongue in the floor of the female clamp to depress, thereby allowing the at least one male protrusion to sink into the at least one female slot

11. The method of claim 8, wherein the pressure causes the protrusions on the male clamp to force over at least one guide rail on the female clamp, thereby allowing the at least one male protrusion to sink into the at least one female slot in the female clamp.

12. The method of claim 8, wherein at least one end of the protrusion is cut at an angle other than a right angle.

13. The method of claim 8, wherein the pressure causes at least one angled sides of the protrusion to push over the guide rails, thereby allowing the at least one protrusion on the male clamp to descend deeper into the trough.

14. The method of claim 8, wherein the pressure causes the at least one protrusion on the male clamp to simultaneously depress the guide rails over and push down a depressible tongue in the floor of the female clamp.

15. A clamping method comprising:
applying pressure to an opposing approximately half-circular male clamp capable of at least partially fitting into a half-circular female clamp;
sensing the inner circumference of at least one of the male and female clamps;
reporting to a computer software program the resistance pressure created from pushing the clamp around an object;
monitoring the pressure of the male and female clamps; and
applying pressure until at least one protrusion on the outer circumference of the male clamp drops into at least one slot in the inner circumference of the female clamp.

16. The method of claim 15, wherein the pressure causes the at least one protrusion on the male clamp to descend into guide rails attached to the female clamp and forming a trough.

17. The method of claim 15, wherein the pressure causes the protrusions on the male clamp to cause a depressible tongue in the floor of the female clamp to depress, thereby allowing the at least one male protrusion to sink into the at least one female slot.

18. The method of claim 15, wherein the pressure causes the protrusions on the male clamp to force over the guide rails on the female clamp, thereby allowing the at least one male protrusion to sink into the at least one female slot.
